(19) United States
(12) Patent Application Publication
(10) Pub. No.: US 2005/0066111 A1
(43) Pub. Date: Mar. 24, 2005

(54) Optical disk reproducing apparatus and optical disk reproducing method

(75) Inventor: Nobunori Mantani, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/912,066

(22) Filed: Aug. 6, 2004

(30) Foreign Application Priority Data
Aug. 8, 2003 (JP) P.2003-289520

(51) Int. Cl. G06F 12/00

(52) U.S. Cl. 711/103

(57) ABSTRACT

An optical disk reproducing apparatus includes a flash memory, and a system controller. Preferably, the flush memory stores a firmware, initial setting information, user setting information and resume information, and the system controller divides an area of the flush memory into blocks, provides the block with a data storage part and a data management part to store data management data corresponding to the data storage areas and representing whether data is valid, determines whether data management data is 0000H when starting a data rewriting processing, initializes data within a block when the data management data is 0000H, retrieves a non-use data storage area where data management data is FFFFH when all the data management data are not 0000H or when data within the block are initialized, writes update data in the non-use data storage area, and sets data management data corresponding to the non-use data storage area to 0000H.

### BACKGROUND OF THE INVENTION

1. Field of the Invention

The present invention relates to an optical disk reproducing apparatus for reproducing information recorded on an optical disk and, in particular, relates to a data rewriting processing for a flash memory.

2. Description of the Related Art

Conventionally, an optical disk reproducing apparatus is provided with a flash memory which stores a firmware for controlling the respective portions of the apparatus, initial setting information, user setting information and resume information at the time of turning-off a power supply. The initial setting information includes information such as language setting information and aspect information. Each of the initial setting information and the user setting information set by a user is also called as set-up information. Such a flash memory is a ROM which is non-volatile and electrically rewritable. The flash memory includes a plurality of blocks each of which is a minimum storage area capable of erasing data and has a data management part for managing data and a data storage part. The storage capacity of the one block (the minimum block) which is the minimum unit capable of erasing data is 8 K bytes (for example)

### SUMMARY OF THE INVENTION

In the conventional optical disk reproducing apparatus, although the initial setting information, the user setting information and the resume information at the time of turning-off a power supply are stored in a flash memory, in the case of rewriting data of these information, data of the corresponding one block is erased and update data is written into the same block. Thus, in the conventional optical disk reproducing apparatus, the number of rewriting procedure for a flash memory accompanied by the erasing procedure increases and so the number of the rewriting procedure reaches a predetermined limit number in a short time period. As a result, the life time of the flash memory is shortened. Further, in the case of rewriting data, since associated one block is required to be entirely erased for each rewriting procedure, much time period is required for erasing and hence the processing speed is lowered.

In view of such a fact, according to the flash memory using method described in JP-A-5-233426, a flash memory is divided into a plurality of sectors, and each of the sectors includes a logical address part, an erasure management part and a data part, wherein at the time of retrieving a sector by the logical address and updating data of the sector, an erasure enable flag of the erasure management part of this sector is set, then the logical address of an empty sector is written into the empty sector and updating data is written in the empty sector.

However, according to this flash memory using method, since each sector includes the logical address part, the erasure management part and the data part etc., at the time of retrieving an empty sector, it is required to sequentially check erasure managing flags set in the erasure management parts of the respective sectors to detect an empty sector, so that the empty sector retrieving processing is complicated and so much processing time is required. In this case, a sector within one block corresponds to one data storage area of the data storage part within one block in an embodiment described later.

The invention has been made in order to solve the aforesaid problem of the conventional technique, and an object of the invention is to provide an optical disk reproducing apparatus which can store data without substantially reducing the rewriting number of times and reduce the rewriting number of times accompanied by an erasing procedure thereby to elongate the life time of a flash memory, and also which can reduce the rewriting number of times accompanied by the erasing procedure at the time of rewriting data thereby to shorten a time period required for the erasing to increase a processing speed.

In order to attain the aforesaid object, according to an aspect of the present invention, an optical disk reproducing apparatus for reproducing information recorded on an optical disk includes a flash memory, and a system controller. Preferably, the flush memory stores a firmware to control respective portions of an apparatus, initial setting information, user setting information and resume information at a time of turning-off a power supply, and the system controller divides an area of the flush memory into blocks each being a minimum unit capable of erasing data and provides each of the blocks with a data management part and a data storage part to store data, the data storage part having a plurality of data storage areas, and the data management part storing data management data which corresponds to each of the data storage areas and represents whether data within each of the data storage areas is valid or not. Preferably, the system controller further includes a management data determining unit to determine whether all of the data management data are 0000H or not at a time of starting a data rewriting processing of the flash memory, a block erasing unit to initialize to erase all data within a corresponding block when all of the data management data are 0000H, a non-use area retrieval unit to retrieve a non-use data storage area where corresponding data management data is FFFFH when all of the data management data are not 0000H or when all data within the corresponding block are initialized and erased, a data writing unit to write update data in the non-use data storage area, and a management data setting unit to set data management data corresponding to the non-use data storage area to 0000H.

According to this configuration, at the time of starting the data rewriting process of the flash memory, when the management data determining unit determines that all of the plural-pieces of the data management data within the data management part is 0000H, the block erasing unit initializes to erase all the data of the block. On the other hand, when the management data determining unit determines that all of the plural-pieces of the data management data is not 0000H or when all the data within the corresponding block is initialized and erased, the non-use area retrieval unit retrieves a non-use data storage area where a corresponding piece of the data management data of the data management part is FFFFH. Then, the data writing unit writes update data in the non-use data storage area thus retrieved, and the management data setting unit sets a piece of the data management data of the data management part corresponding to the non-use data storage area in which the update data is written to 0000H.

According to this configuration, in the case of rewriting data of the flash memory, update data is not written into the same data storage area in which the data before update has been stored but is written into the non-use storage area which differs from the same data storage area. Thus, data can be stored without substantially reducing the rewriting number of times and the rewriting number of times accompanied by an erasing procedure can be reduced. As a result, the life time of the flash memory can be elongated, and also at the time of rewriting data, since the rewriting number of times accompanied by an erasing procedure can be reduced, a time period required for the erasing can be reduced and so a processing speed can be increased.

According to another aspect of the present invention, an optical disk reproducing apparatus for reproducing information recorded on an optical disk includes a flash memory, and a system controller. Preferably, the flush memory stores a firmware to control respective portions of an apparatus, initial setting information, user setting information and resume information at a time of turning-off a power supply, and the system controller divides an area of the flush memory into blocks each being a minimum unit capable of erasing data, and provides each of the blocks with a data management part and a data storage part to store data, the data storage part having a plurality of data storage areas, and the data management part storing data management data which corresponds to each of the data storage areas and represents whether data within each of the data storage areas is valid or not. Preferably, the system controller writes update data into a non-use data storage area at a time of performing a data rewriting processing of the flash memory when the non-use data storage area exists, and sets the data management data corresponding to the non-use data storage area to represent valid.

According to this configuration, at the time of starting the data rewriting process of the flash memory, when there is a non-use data storage area, update data is written into this non-use data storage area and a piece of the data management data of the data management part corresponding to the non-use data storage area in which the update data is written is set to represent valid.

According to this configuration, at the time of rewriting data of the flash memory, update data is not written into the same data storage area in which the data before update has been stored but is written into the non-use storage area which differs from the same data storage area. Thus, data can be stored without substantially reducing the rewriting number of times and the rewriting number of times accompanied by an erasing procedure can be reduced. As a result, the life time of the flash memory can be elongated. Further, at the time of rewriting data, since the rewriting number of times accompanied by an erasing procedure can be reduced, a time period required for the erasing can be reduced and so a processing speed can be increased.

According to yet another aspect of the present invention, an optical disk reproducing method for reproducing information recorded on an optical disk including dividing an area of a flush memory into blocks each being a minimum unit capable of erasing data, providing each of the blocks with a data management part and a data storage part to store data, the data storage part having a plurality of data storage areas, and the data management part storing data management data which corresponds to each of the data storage areas and represents whether data within each of the data storage areas is valid or not, determining whether all of the data management data are 0000H or not at a time of starting a data rewriting processing of the flash memory, initializing to erase all data within a corresponding block when all of the data management data are 0000H, retrieving anon-use data storage area where corresponding data management data is FFFFH when all of the data management data are not 0000H or when all data within the corresponding block are initialized and erased, writing update data in the non-use data storage area, and setting management data corresponding to the non-use data storage area to 0000H.

As described above, according to the invention, the optical disk reproducing apparatus is provided with the system controller which includes the management data determining unit for determining whether all of the plural-pieces of the data management data of the data management part is 0000H or not at a time of starting a data rewriting processing of the flash memory, the block erasing unit for initializing to erase all data within a corresponding block when all of the plural-pieces of the data management data is 0000H, the non-use area retrieval unit for retrieving a non-use data storage area where a corresponding piece of the data management data of the data management part is FFFFH when all of the plural-pieces of the data management data of the data management part is not 0000H or when all data within the corresponding block is initialized and erased, the data writing unit for writing update data in the non-use data storage area thus retrieved, and the management data setting unit for setting a piece of the data management data of the data management part corresponding to the non-use data storage area in which the update data is written to 0000H. Thus, data can be stored without substantially reducing the rewriting number of times and the rewriting number of times accompanied by an erasing procedure can be reduced. As a result, the life time of the flash memory can be elongated. Further, at the time of rewriting data, since the rewriting number of times accompanied by an erasing procedure can be reduced, a time period required for the erasing can be reduced and so a processing speed can be increased.

Further, according to the invention, there is provided with the system controller wherein at the time of starting the data rewriting process of the flash memory, when there is a non-use data storage area, update data is written into this non-use data storage area and a piece of the data management data of the data management part corresponding to the non-use data storage area in which the update data is written is set to represent valid. Thus, in the case of rewriting data of the flash memory, update data is not written into the same data storage area in which the data before update has been stored but is written into the non-use storage area which differs from the same data storage area. Thus, data can be stored without substantially reducing the rewriting number of times and the rewriting number of times accompanied by an erasing procedure can be reduced. As a result, the life time of the flash memory can be elongated, and also at the time of rewriting data, since the rewriting number of times accompanied by an erasing procedure can be reduced, a time period required for the erasing can be reduced and so a processing speed can be increased.

### BRIEF DESCRIPTION OF THE DRAWINGS

Preferred embodiment of the present invention will be described in detail based on the following figures, wherein:

FIG. 1 is a block diagram showing the configuration of an optical disk reproducing apparatus according to the embodiment of the invention;

FIG. 2 is a diagram showing the block of the flash ROM in the optical disk reproducing apparatus according to the embodiment; and

FIG. 3 is a flow chart showing the data rewriting process of the flash ROM in the optical disk reproducing apparatus according to the embodiment.

### DETAILED DESCRIPTION OF THE INVENTION

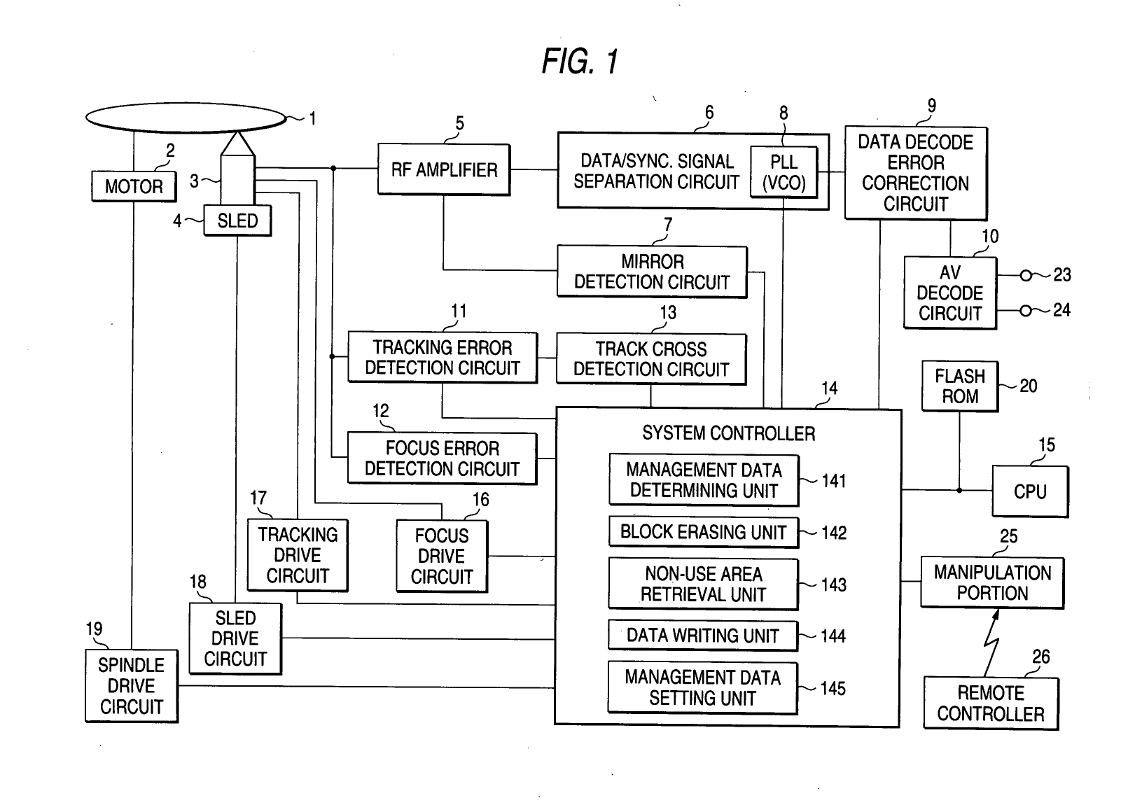

An embodiment of the invention will be explained with reference to accompanying drawings. FIG. 1 is a block diagram showing the configuration of an optical disk reproducing apparatus according to the embodiment of the invention. As shown in FIG. 1, the optical disk reproducing apparatus includes an optical pickup 3 for emitting laser light for reproducing information recorded on an optical disk 1 such as a DVD and receiving reflection light from the optical disk 1, a spindle motor 2 for rotating the optical disk 1, a spindle drive circuit 19 for driving the spindle motor 2, a tracking drive circuit 17 for driving an actuator (not shown) for performing the tracking servo control of the optical pickup 3, a focus drive circuit 16 for driving an actuator (not shown) for performing the focusing servo control of the optical pickup 3, a sled 4 for moving the optical pickup 3 in the radial direction of the optical disk 1, and a sled drive circuit 18 for driving the sled 4.

Further, the optical disk reproducing apparatus includes an RF amplifier 5 for, at the time of reproduction of the optical disk 1, inputting a reproduction signal (read signal) from the optical disk 1 and generating an RF signal from the reproduction signal and amplifying the RF signal, a data/sync. signal separation circuit 6 which includes a PLL (phase locked loop) 8 having a VCO (voltage controlled oscillator) and inputs the RF signal from the RF amplifier 5 to separate the RF signal into data and a synchronous signal, a data decode error correction circuit 9 which inputs the data thus separated by the data/sync. signal separation circuit 6 to decode the data thereby to perform error check and which performs the error correction when the data is erroneous thereby to output correct data, and an AV decode circuit 10 which inputs and decodes the correct date from the data decode error correction circuit 9 to supply a video signal and an audio signal to a not-shown TV monitor etc., for example, through a video output terminal 23 and an audio output terminal 24, respectively.

Furthermore, the optical disk reproducing apparatus includes a mirror detection circuit 7 which detects a mirror signal contained in the RF signal from the RF amplifier 5 and representing the mirror surface having no track on the optical disk 1 and counts the mirror surfaces, a tracking error detection circuit 11 for detecting a tracking error signal contained in the reproduction signal from the optical pickup 3, a focus error detection circuit 12 detecting a focus error signal contained in the reproduction signal from the optical pickup 3, and a track cross detection circuit 13 which detects a track cross based on the tracking error signal from the tracking error detection circuit 11 to output a track pulse.

Furthermore, the optical disk reproducing apparatus includes a manipulation portion 25 which is provided on the front panel etc. of the main body of this apparatus and has a plurality of keys for performing various operations relating to the on/off operations of the power supply of the apparatus and the reproduction operation etc. The manipulation portion 25 includes a photo receiving unit (not shown) for receiving a light signal representing an operation command sent from a remote controller 26. The photo receiving unit converts the light signal into an electric signal and inputs the electric signal as a command signal to a system controller 14. The remote controller 26 has a plurality of keys (not shown) for performing various operations relating to the on/off operations of the power supply of the apparatus and the reproduction operation etc.

The optical disk reproducing apparatus furthermore includes a flash ROM 20 as a flash memory which stores a firmware for controlling the respective portions of the apparatus, initial setting information, user setting information and resume information at the time of turning-off the power supply, a CPU 15 for performing the entire processing of the apparatus based on the firmware, and the system controller 14 for controlling the aforesaid respective constituent elements.

The system controller 14 performs the focus servo control of the optical pickup 3 based on the focus error signal contained in the reproduction signal from the optical pickup 3, the tracking servo control of the optical pickup 3 based on the tracking error signal contained in the reproduction signal from the optical pickup 3, the control of driving the sled 4 through the sled drive circuit 18 in accordance with the reproduction command signal from the manipulation portion 25 and the remote controller 26 in order to determine the reproduction position of the optical disk 1 thereby to move the optical pickup 3 in the radial direction of the optical disk 1, and the control of rotating the spindle motor 2 through the spindle drive circuit 19 in accordance with an operation signal from the manipulation portion 25 and the remote controller 26.

The system controller 14 includes a management data determining unit 141 for determining whether all of plural-pieces of the data management data of a data management part is 0000H or not at the time of starting the data rewriting processing of the flash ROM 20, a block erasing unit 142 for initializing to erase all the data within a corresponding block when all of the plural-pieces of the data management data is 0000H, a non-use area retrieval unit 143 for retrieving a non-use data storage area where the corresponding piece of the data management data of the data management part is FFFFH when all of the plural-pieces of the data management data of the data management part is not 0000H or when all the data within the block is initialized and erased, a data writing unit 144 for writing update data in the non-use data storage area thus retrieved, and a management data setting unit 145 for setting a piece of the data management data of the data management part corresponding to the non-use data storage area in which the update data is written to 0000H.

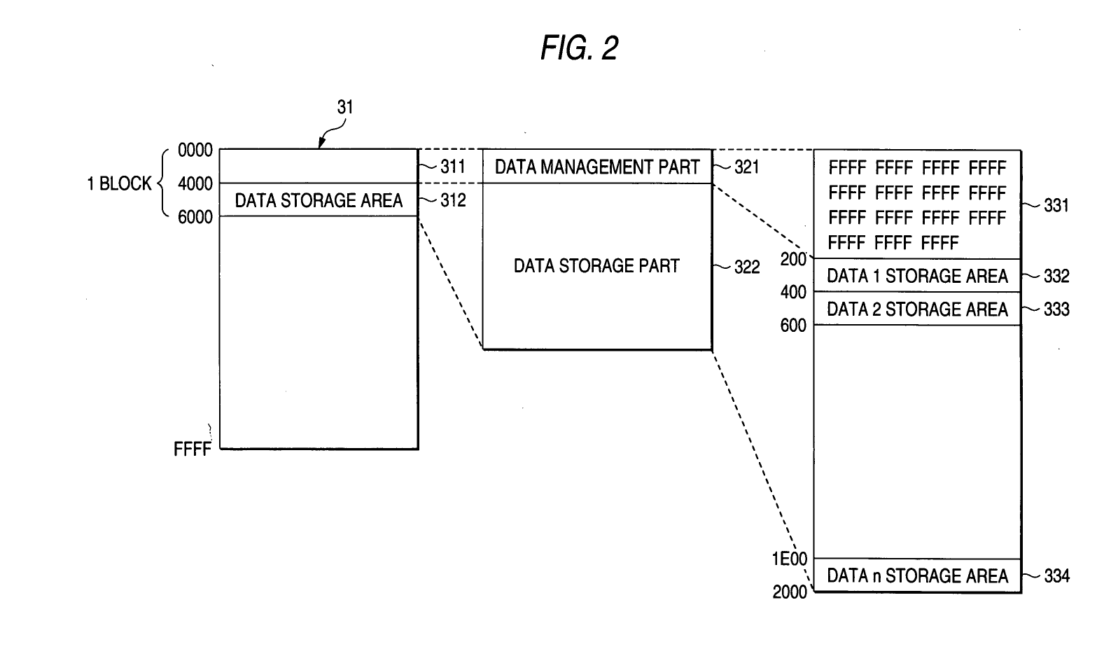

FIG. 2 is a diagram showing the block of the flash ROM in the optical disk reproducing apparatus according to the embodiment. In FIG. 2, a reference numeral 31 depicts areas of addresses 0000 to FFFF in the flash ROM. Areas 311 and 312 of the addresses 0000 to 6000 is one block which is the minimum unit capable of erasing data. Of the one block, the area 311 is used as a data management part 321, the area 312 is used as a data storage part 322. A reference numeral 331 depicts a data storage area in which n-pieces of the data management data of the data management part 321 is stored, 332 depicts a data 1 storage area within the data storage part 322, 333 depicts a data 2 storage area within the data storage part 322, and 334 depicts a data n storage area within the data storage part 322.

In general, the storage capacity of the flash ROM is not constant and includes the data management part 321 for managing data and the data storage part 322 for storing data within one block. When the data storage part 322 is initialized, the data thereof is set to FFFF as shown within the data management area 331. “FFFF” means that there is no data within the data storage area.

For example, when the data at the most left side of the uppermost portion of the data management area 331 is FFFF, it means that there is no data within the data 1 storage area 332. In contrast, when the data at the most left side of the uppermost portion of the data management area 331 is not FFFF but 0000, it means that there is data within the data 1 storage area 332. Thus, when it is desired to rewrite the data of the data 1 storage area 332, the data at the most left side of the uppermost portion of the data management area 331 is changed from FFFF to 0000 thereby to rewrite data of the data 1 storage area 332.

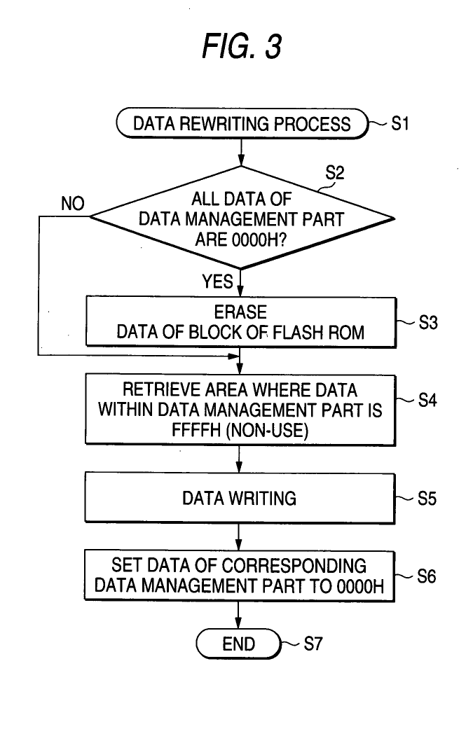

FIG. 3 is a flow chart showing the data rewriting process of the flash ROM in the optical disk reproducing apparatus according to the embodiment. The data rewriting process of the flash ROM will be explained with reference to the flow chart.

When the data rewriting process of the flash ROM 20 is started (step S1), the management data determining unit 141 of the system controller 14 determines whether all of plural-pieces of the data management data within the data management area 331 of the data management part 321 is 0000H or not (step S2). When all of plural-pieces of the data management data is determined to be 0000H, the block erasing unit 142 initializes to erase all the data of the block (step S3).

In contrast, when all of plural-pieces of the data management data is determined not to be 0000H or when all the data of the block is initialize and erased, the non-use area retrieval unit 143 retrieves a non-use data storage area where the corresponding piece of the data management data within the data management area 331 of the data management part 321 is FFFFH (step S4).

Next, the data writing unit 144 writes update data in the non-use data storage area thus retrieved (step S5), and the management data setting unit 145 sets a piece of the data management data of the data management part 321 corresponding to the non-use data storage area in which the update data is written to 0000H (step S6), thereby terminating the data rewriting process (step S7).

### FIG. 1

2 MOTOR
4 SLED
5 RF AMPLIFIER
6 DATA/SYNC. SIGNAL SEPARATION CIRCUIT
7 MIRROR DETECTION CIRCUIT
9 DATA DECODE ERROR CORRECTION CIRCUIT
10 AV DECODE CIRCUIT
11 TRACKING ERROR DETECTION CIRCUIT
12 FOCUS ERROR DETECTION CIRCUIT
13 TRACK CROSS DETECTION CIRCUIT
14 SYSTEM CONTROLLER
16 FOCUS DRIVE CIRCUIT
17 TRACKING DRIVE CIRCUIT
18 SLED DRIVE CIRCUIT
19 SPINDLE DRIVE CIRCUIT
20 FLASH ROM
23 VIDEO SIGNAL
24 AUDIO SIGNAL
25 MANIPULATION PORTION
26 REMOTE CONTROLLER
141 MANAGEMENT DATA DETERMINING UNIT
142 BLOCK ERASING UNIT
143 NON-USE AREA RETRIEVAL UNIT
144 DATA WRITING UNIT
145 MANAGEMENT DATA SETTING UNIT

1. An optical disk reproducing apparatus for reproducing information recorded on an optical disk comprising:
a flash memory; and
a system controller,
wherein
the flush memory stores a firmware to control respective portions of an apparatus, initial setting information, user setting information and resume information at a time of turning-off a power supply,
the system controller divides an area of the flush memory into blocks each being a minimum unit capable of erasing data, and provides each of the blocks with a data management part and a data storage part to store data,
the data storage part has a plurality of data storage areas, and
the data management part stores data management data which corresponds to each of the data storage areas and represents whether data within each of the data storage areas is valid or not,
and wherein
the system controller further includes
a management data determining unit to determine whether all of the data management data are 0000H or not at a time of starting a data rewriting processing of the flash memory,
a block erasing unit to initialize to erase all data within a corresponding block when all of the data management data are 0000H,
a non-use area retrieval unit to retrieve a non-use data storage area where corresponding data management data is FFFFH when all of the data management data are not 0000H or when all data within the corresponding block are initialized and erased,
a data writing unit to write update data in the non-use data storage area,
and a management data setting unit to set data management data corresponding to the non-use data storage area to 0000H.

2. An optical disk reproducing apparatus for reproducing information recorded on an optical disk comprising:
a flash memory; and
a system controller,
wherein
the flush memory stores a firmware to control respective portions of an apparatus, initial setting information, user setting information and resume information at a time of turning-off a power supply,
the system controller divides an area of the flush memory into blocks each being a minimum unit capable of erasing data, and provides each of the blocks with a data management part and a data storage part to store data,
the data storage part has a plurality of data storage areas, and
the data management part stores data management data which corresponds to each of the data storage areas and represents whether data within each of the data storage areas is valid or not,
and wherein
the system controller
at a time of performing a data rewriting processing of the flash memory, when a non-use data storage area exists, writes update data into the non-use data storage area, and
sets the data management data corresponding to the non-use data storage area to represent valid.

3. The optical reproducing apparatus according to claim 2, wherein
when the data management data is a predetermined first code, the data management data represents that a corresponding data storage area is not used, and
when the data management data is a predetermined second code, the data management data represents that the corresponding data storage area is used and the data therein is valid.

4. The optical reproducing apparatus according to claim 3, wherein
the predetermined first code is FFFFH, and
the predetermined second code is 0000H.

5. The optical reproducing apparatus according to claim 2, wherein
the system controller further includes
a management data determining unit to determine whether all of the data management data are the predetermined second code or not at a time of starting a data rewriting processing of the flash memory,
a block erasing unit to initialize to erase all data within a corresponding block when all of the data management data are the predetermined second code,
a non-use area retrieval unit to retrieve a non-use data storage area where corresponding data management data is the predetermined first code when all of the data management data are not the predetermined second code or when all data within the corresponding block are initialized and erased,
a data writing unit to write update data in the non-use data storage area,
and a management data setting unit to set data management data corresponding to the non-use data storage area to the predetermined second code.

6. The optical reproducing apparatus according to claim 5, wherein
the predetermined first code is FFFFH, and
the predetermined second code is 0000H.

7. An optical disk reproducing method for reproducing information recorded on an optical disk comprising:
dividing an area of a flush memory into blocks each being a minimum unit capable of erasing data,
providing each of the blocks with a data management part and a data storage part to store data, the data storage part having a plurality of data storage areas, and the data management part storing data management data which corresponds to each of the data storage areas and represents whether data within each of the data storage areas is valid or not,
determining whether all of the data management data are 0000H or not at a time of starting a data rewriting processing of the flash memory,
initializing to erase all data within a corresponding block when all of the data management data are 0000H,
retrieving a non-use data storage area where corresponding data management data is FFFFH when all of the data management data are not 0000H or when all data within the corresponding block are initialized and erased,
writing update data in the non-use data storage area, and
setting management data corresponding to the non-use data storage area to 0000H.
